(19) United States
(12) Patent Application Publication
(10) Pub. No.: US 2010/0195780 A1
(43) Pub. Date: Aug. 5, 2010

(54) Apparatus and process for thermal gradient-driven metal catalyzed fusion reactor

(76) Inventor: Talbot Albert Chubb, Arlington, VA (US)

Correspondence Address: Melvin L. Crane, 318 South Cleveland Street, Arlington, VA, 22204-2038, US

(21) Appl. No.: 12/320,799

(22) Filed: Feb. 5, 2009

(51) Int. Cl. G21B 3/00

(52) U.S. Cl. 376/100; 976/DIG. 1; 977/903

(57) ABSTRACT

A deuterium-fueled heat-generating reactor that uses a nano-metal catalyst in a catalyst bed, in combination with an operator adjustable means for imposing a temperature gradient within the catalyst bed so as to stimulate and control an exothermic nuclear reaction rate.

### RELATED PATENT APPLICATION

This application is related to application Ser. No. 12/283,794, filed Dec. 17, 2008.

### BACKGROUND OF THE INVENTION

1. Field of the Invention

This invention relates to heat generating processes, and more particularly to heat generating processes in which deuterium participates in exothermic nuclear reactions in condensed matter. Further, the invention is directed to low energy nuclear reactions taking place in condensed matter, which includes radiationless cold nuclear fusion. In particular, it is directed to production of heat by the interaction of deuterium with a nano-metal catalyst.

2. Description of the Prior Art

The invention is an improvement over the apparatus and process used by Arata and Zhang in 2008 to demonstrate the release of nuclear fusion heat from a ZrO₂+nanoPd composite “nuclear” catalyst. The catalyst released heat in two steps after being subjected to pressurized D₂ gas. When first subjected to D₂ gas the catalyst increased in temperature in response to a chemical reaction that formed Pd deuteride PdDₓ, where x rose from 0 to about 2. The chemical reaction heat flowed from catalyst to the reactor wall and from the reactor wall to the surrounding area. This relatively short duration release of chemical heat was followed by a second period of heat release in which there was a multiple-day release of nuclear reaction heat, which similarly flowed from catalyst to reactor wall and from reactor wall through thermal insulation to room, showing almost no decrease in heat flow rate during a run lasting hundreds of hours. Measurement of post-run helium showed that the nuclear reaction heat was at least partially due to the nuclear fusion of deuterium to helium-4 (⁴He). The nuclear fusion reaction releases 10,000,000 times the energy per consumed fuel molecule than that released by chemical combustion. When Arata and Zhang substituted H₂ gas for D₂ gas, no multiple-day release of heat occurred, and no post-run ⁴He was observed.

Arata and Zhang published cold fusion heat studies in 1992 in a paper titled “A New Energy Caused by ‘Spillover-Deuterium’”. In this study deuterium was electroplated onto the Pd wall of a closed vessel which contained Pd-back catalyst. They observed more energy flowing out of their apparatus that the electrical energy expended in electroplating process. They attributed this excess energy to the release of essentially radiationless dd-fusion nuclear reaction heat.

Part of the technology that contributed to their reaction success was a discovery that unreduced Pd-black catalyst, when evacuated and subsequently pressurized with inflowing hydrogen gas, reacts with the initial inflow without showing an expected rise in pressure. This behavior contrasts with the rise in pressure recorded when palladium filings are used. They concluded that the inflowing hydrogen distributed itself throughout the catalyst mass and chemically combined with the Pd grains at a pressure too low to record. They named this rapidly absorbed hydrogen “spillover hydrogen”. Their unreduced Pd-black had a tap density of less than 1 g/cm² and reacted with the inflowing hydrogen like a chemical getter pump. The catalyst density was less than one tenth the density of Pd metal. In this patent application we refer to catalyst that shows getter-like hydrogen absorption “spillover catalyst”. We call a mass containing spillover catalyst a “spillover catalyst bed”.

In 2002 Arata and Zhang found a second type of catalyst that showed a larger spillover effect that their Pd-black. The new catalyst, developed by Yamaura et al. at Tohoku University contains nanometer Pd inside ZrO₂ crystal. It is called ZrO₂+nanoPd. Arata and Zhang substituted the ZrO₂+nanoPd for their Pd-black in the electrolysis apparatus that they had been developing and testing between 1992 and 2001, and observed improved production of nuclear reaction heat.

The reactor apparatus used in the studies carried out between 1992 and 2001 was a concentric double-vessel reactor with outer and inner vessels. Their process used an electrolysis cell filled with a heavy water (D₂O) electrolyte from which deuterium was plated onto the cylindrical surface of the inner vessel. The inner vessel had the form of a metal bottle with a cylindrical Pd wall through which deuterium diffused. Prior to 2002 deuterium emerging from the inside surface of the Pd metal made contact with, and was absorbed by a spillover bed of Pd-black catalyst. The apparatus was called a DS-cathode. The 2002 study with ZrO₂+nanoPd catalyst demonstrated 10 watts of excess heat power for 3 weeks, as calculated by subtracting electrolysis input power from outflow heat power.

In 2005 Arata and Zhang changed their heat production process from electrolysis loading to gas loading. They removed the electrolyte from their electrolysis cell and replaced it with high pressure D₂ gas, but kept the concentric cylinder construction. During gas loading the D₂ molecules dissociated into D-atoms on the Pd cylinder which served as the cylinder wall of the reactor's inner vessel, designated “inner vessel”. The D-atoms diffused through the vessel's Pd wall and were absorbed by nanoPd spillover catalyst contained within the inner vessel. Comparison tests were carried out using both Pd-black and ZrO₂+nanoPd catalysts. In all these tests Arata and Zhang operated their “gas loading” reactor at ˜140° C. temperature, using an electrical heater in contact with the outer wall of the reactor to raise the reactor wall temperature to ˜140° C. before D₂ gas was used to fill the space between the inner and outer cylinders. In the 2005 study the nuclear heat power was demonstrated by examining the long-duration temperature difference between inner and outer vessels observed late in long duration runs. When D₂ gas was used to load Pd-black spillover catalyst, the catalyst temperature was higher than the reactor wall temperature. When H₂ gas was used with Pd-black spillover catalyst, the catalyst temperature was lower than the reactor wall temperature. The reversal in temperature difference showed that nuclear heat was being released inside the catalyst bed when D₂ gas was used, and not when H₂ gas was used.

Substitution of ZrO₂+nanoPd spillover catalyst for Pd-black caused a factor of 8 increase in the temperature difference between catalyst and reactor wall. This increase was accompanied with an increase in reactor wall temperature that permitted calculation of the total nuclear output power. The increase in the difference between reactor wall temperature and room temperature means that an increase in heat flow through the insulation wrapping had occurred. The increase was equal to 33% of the temperature difference produced by the electrical heater used to maintain the ˜140° C. temperature prior to D₂ gas pressurization. Since the heater power required to maintain a steady ˜140° C. was measured to be 1.7 watts and the fusion heat component was 33% of this temperature-maintaining heater power, the fusion heat power could be calculated. The calculated fusion power was 0.6 watts.

The 0.6 watts of fusion heat from gas-loaded ZrO₂+nanoPd catalyst is much less than the 10 W obtained using electrolysis loading for roughly the same amount of catalyst. The higher heat flow obtained with electrolysis was due to flow stimulation. Steady Arata and Zhang electrolysis process causes a steady deuterium flow through the catalyst bed. The observed higher power output achieved using electrolysis demonstrates that deuterium flow through the catalyst stimulates higher nuclear heat output.

In a different context, the value of flow stimulation is shown in studies by McKubre et al. Their studies, cited as Prior Art, have shown episodic nuclear fusion heat release in bulk Pd metal, but only when there was a net flow of deuterium into and out of a Pd metal cathode, independent of direction. The value of flow stimulation was also shown in studies by Iwamura et al, (1998), cited as Prior Art. The Iwamura studies used a constant deuterium permeation flow through a Pd reactor plate containing a dispersion of CaO crystals. Their experiments showed nuclear heat release in Pd reactor plates containing embedded oxide and not when the CaO was omitted. Also, no nuclear heat release was seen when H₂ was used instead of D₂. The function of CaO crystals in the Iwamura et al. (1998) studies parallels that of ZrO₂ crystals in the Arata and Zhang (2002) study.

The prior art and the Arata and Zhang 2005 and 2008 studies show that significant nuclear heat power can be achieved within a spillover catalytic nanoPd medium without imposing a continuing permeation deuterium flow through the reaction medium, but the level of heat power is lower than occurs when a continuing permeation flow is maintained within the catalytic medium. Deuterium flow has a stimulation effect. The apparatus and process of the invention provides controllable deuterium flow through a ZrO₂+nanoPd composite catalyst bed, adding a controlled flow stimulation heat addition to the nuclear reaction heat release present when no deuterium permeation flow is provided. The invention apparatus provides flow stimulation using closed-loop flow produced by using electrochemical means without the use of a mechanical pump. The electrochemical means includes moisture control and voltage limitation to ensure long life deuterium flow stimulation.

### SUMMARY OF THE INVENTION

The invention describes apparatus and process which causes deuterium to participate in an exothermic nuclear reaction in a condensed matter environment. The process uses a temperature gradient within a powdered spillover catalyst bed to create a closed-loop deuterium flow between a hotter portion of the catalyst bed and a cooler portion of the same catalyst bed. The closed-loop flow is a counter-flow circulation. It is the sum of two different types of deuterium flow and results in an enhanced nuclear reaction rate within the catalyst bed. The nuclear reactions produce heat without production of energetic particles or gamma rays.

The gas pressure in equilibrium with the hotter catalyst grains is higher than the gas pressure in equilibrium with the cooler catalyst grains. This gas pressure gradient drives the flow of deuterium gas through the interstices between grains. The absorption of gas by the cooler catalyst grains creates a higher concentration of deuterium in and on the catalyst grains. The concentration gradient of adsorbed deuterium causes diffusion of deuterium from the surface of the cooler grains to the surface of the hotter grains. The flow of deuterium on the surfaces and in the interior of the grains stimulates nuclear reaction, generating increased nuclear heat.

### OBJECTS OF THE INVENTION

It is therefore an object of the invention to provide a device from which nuclear energy is released and converted to heat within a catalyst bed;

Another object of the invention is to provide heat from nuclear energy by use of nuclear reactions in which deuterium participates as a reactant;

Still another objective is to provide heat from nuclear energy without the emission of energetic particles, neutrons, or gamma radiation, such as accompanies heat generation in commercial nuclear power plants;

Yet another object is to provide heat from nuclear energy in a device that is small enough to be suitable for heating a room.

Another object is to enhance heat production over what occurs under static, no-deuterium-flow conditions.

### BRIEF DESCRIPTION OF DRAWINGS

FIG. 1 is a side view schematic cross sectional drawing of a reactor whose shape is that of a right circular cylinder.

FIG. 2 is a side view schematic cross sectional drawing of a reactor whose shape is that of a right circular cylinder.

### DETAILED DESCRIPTION

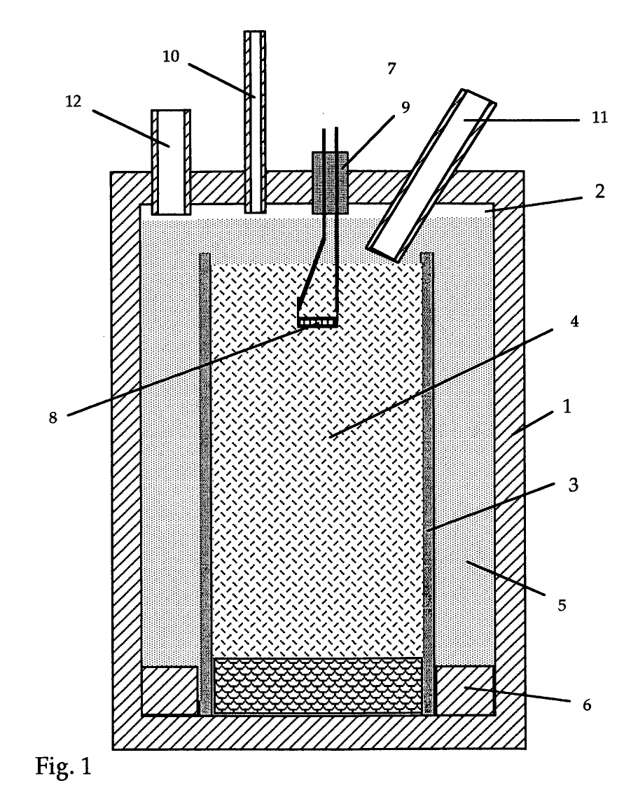

In the implementation shown in FIG. 1, the Apparatus is a closed-cylinder catalytic nuclear reactor. The reactor vessel wall 1 includes therein D₂ gas 2 which fills the interior volume of the reactor vessel at a pressure in the range 1-100 atmospheres and functions as a nuclear fuel. Within the reactor vessel a cylindrical tubular container 3 formed of low thermal conductivity material such as glass is partially filled with a “spillover-effect” catalyst bed 4 that promotes a 2D₂→⁴He nuclear fusion reaction. The annular space between tubular container 3 and reactor wall 1 is filled with thermal insulation powder such as glass beads 5. Thermal insulation glass beads 5 also cover the top surface of spillover catalyst bed 4. Catalyst bed 4 may be made from Pd-black powder coated with adsorbed water, or may be made from a Pd heterogeneous nanocrystal powder such as powdered ZrO₂+nanoPd composite, or may be in the form of a Pd heterogeneous nanocrystal material containing ionic crystals supported on a porous substrate, or may be in the form of a Pd heterogeneous nanocrystal material containing ionic crystals with the material deposited on fine fibers. Tubular container 3 is restricted in motion by metal annular ring 6. The bottom of catalyst bed 4 rests on thermally conductive material 7 such as an aluminum bead bed made up of hollow aluminum beads, providing a thermally conductive interface between catalyst bed 4 and reactor wall 1. Electrical resistor 8 provides a steady source of heat within catalyst bed 4, from which heat flows into catalyst bed 4 producing a thermal gradient within catalyst bed 4. Feed-through insulator 9 containing two support wires connects resistor 8 to an external source of electrical power, which is not shown. Gas fill-tube 10 penetrates reactor wall 1 and connects to an outside manifold which provides the operator with choice of vacuum or deuterium gas for reactor preparation and for reactor fill with deuterium gas fuel 2. Catalyst fill-tube 11 penetrates reactor wall 1 to permit reactor operator to partially fill open cylinder 3 with aluminum beads 7 and catalyst bed powder 4. Thermal insulation fill-tube 12 penetrates reactor wall 1 to permit reactor operator to fill the annular volume between open cylinder 3 and reactor 1 with thermal insulation beads 5, and also to partially fill the space within reactor 1 between catalyst bed 4 and the top plate portion of reactor 1. Pressure-tight closure caps to fill-tubes 11 and 12 are not shown.

The thermal gradient-stimulated metal catalyzed nuclear reactor is an apparatus that supports a catalytic fusion reaction liberating heat that flows through the reactor wall 1 to the surrounding area. In this process, the reactor functions as a heater which heats its surroundings. The nuclear reaction is catalyzed by spillover catalyst bed 4. ZrO₂+nanoPd spillover catalyst was used in a catalyst bed as the active component in a gas-loaded deuterium fusion reactor as described in Arata and Zhang (2008). The improved catalytic reactor adds a deuterium fluxing capability to the Arata and Zhang 2008 reactor. The deuterium fluxing device is driven by a thermal gradient counter-flow “pump”, which drives a closed-loop circulation of deuterium through the catalyst material without the use of mechanical pumping, and which provides a concentration gradient-driven upward deuterium diffusive flow within the catalyst bed.

The operator controls the magnitude of the concentration gradient deuterium diffusion flow by controlling the voltage applied to resistor 8. When zero voltage is applied to resistor 8, the D/Pd ratio assumes the same value throughout catalyst bed 4. When voltage is applied to resistor 8, the nearby hotter portion of the catalyst bed loses chemically bound deuterium and increases the local pressure of D₂ gas. The expelled D₂ gas flows away, decreasing the upper-bed D/Pd ratio. The downward portion of the expelled D₂ gas flow constitutes a downward flow of gas through communicating empty spaces between grains in the catalyst bed powder. The overall increase in gas pressure causes a higher D/Pd ratio at the bottom of the bed. The higher D/Pd ratio at the bottom of the bed and the lower D/Pd ratio at the top of the bed drives an upward deuterium diffusion flow between and within communicating catalyst bed grains. This concentration-driven diffusion flow balances the downward interstitial D₂ gas flow. The magnitude of the diffusion flow rate is the deuterium fluxing rate. Deuterium fluxing stimulates the fusion reaction.

Assembly steps start with reactor machined parts, assembled and welded together to form a pressure tight vessel except for open fill-tube ports. Steps are: 1) pour aluminum beads followed by catalyst powder into catalyst fill-tube 11 and cap fill-tube 11, 2) pour thermal insulation beads into thermal insulation fill-tube 12 and cap fill-tube 12, connect gas-fill tube to external gas manifold, evacuate reactor vessel, and back fill with pressurized deuterium gas, 3) apply electrical power to resistor embedded in catalyst bed so as to create a thermal gradient within the catalyst bed, 4) adjust voltage applied to resistor 8 to create desired heat generation power within reactor vessel.

Fabrication of reactor 1 starts with a section of ss tubing and two flat plate disks sized to fit within and to seal-off the ends of the segment of tubing. The bottom flat plate is welded to the bottom end of the open cylinder. The top flat plate is machined to receive fill-tubes 10, 11, and 12, and feedthrough fitting 9. Fill-tubes 10, 11, and 12 are welded to the top plate. Feedthrough fitting 9 is secured to the top plate by means such as soldering. Resistor 8 connection wires are sealed to feedthrough fitting 9 by means such as soldering. Annular metal ring 6 is seated snugly into reactor 1, and glass cylinder 3 is seated snugly within annular metal ring 6. The top plate is then secured to the top of the reactor by means such as welding, thereby sealing reactor 1 except for the open fill-tubes.

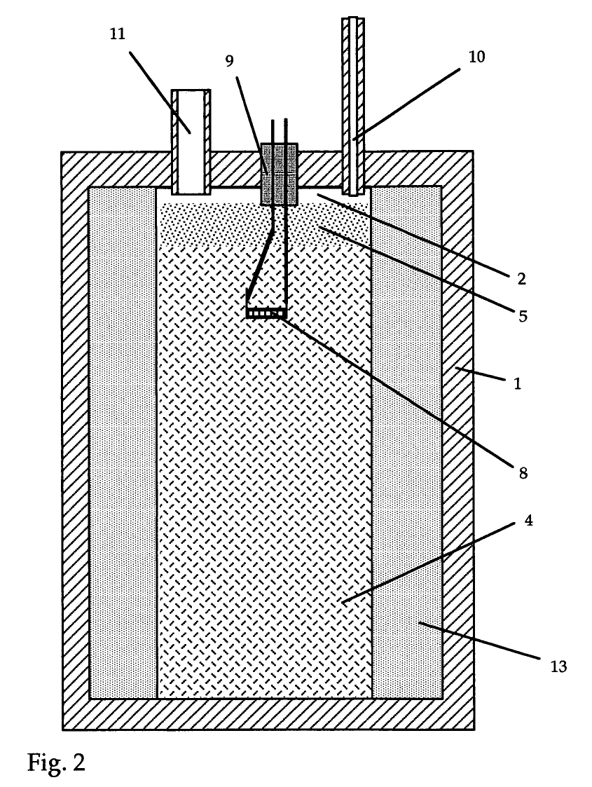

In the implementation shown in FIG. 2, the Apparatus is a closed-cylinder catalytic nuclear reactor, as in FIG. 1. The reactor vessel wall 1 includes therein D₂ gas 2 which fills the interior volume of the reactor vessel at a pressure in the range 1-100 atmospheres and functions as a nuclear fuel. Within the reactor vessel rigid aerogel open cylinder 13 made of low thermal conductivity material contains a “spillover-effect” catalyst bed 4 that promotes a 2 D₂→⁴He nuclear fusion reaction. Thermal insulation glass beads 5 cover the top surface of catalyst bed 4. The bottom of catalyst bed 4 rests on the bottom flat plate of reactor 1. Electrical resistor 8 provides a source of heat within catalyst bed 4, from which heat flows into catalyst bed 4 so as to create a thermal gradient within catalyst bed 4. Feed-through insulator 9 containing two support wires connects resistor 8 to an external source of electrical power, which is not shown. Gas fill-tube 10 penetrates reactor wall 1 and connects to an outside manifold which provides the operator with choice of vacuum or deuterium gas for reactor preparation and for reactor fill with deuterium gas fuel 2. Catalyst fill-tube 11 penetrates reactor wall 1 to permit reactor operator to partially fill open cylinder 3 with catalyst bed powder 4 and insulation beads 5. A pressure-tight closure cap to fill-tube 11 is not shown.

In FIG. 2 the thermal insulation used to obstruct heat flow through the cylindrical wall of reactor 1 is open cylinder 13 constructed of a solid foam insulation like aerogel. Items 3 and 6 of FIG. 1 are eliminated. Slanted open cylinder 11 of FIG. 1 is replaced by vertical cylinder 11. Vertical cylinder 12 of FIG. 1 is eliminated.

Operation of Apparatus described in FIG. 2 is substantially the same as that described for FIG. 1.

What is claimed:

1. Apparatus and process for generating heat by exothermic nuclear reaction in which deuterium participates, comprising a pressure tight reactor vessel containing a gas reservoir volume and a spillover catalyst bed, means for evacuating and deuterium pressurizing the reservoir and catalyst bed prior to first use, means to seal the reactor after reactor assembly and after evacuation and pressurization prior to first use, means for increasing the temperature of a local region in the upper portion of the gas-filled catalyst bed relative to the lower portion of the same catalyst bed, thermal conduction means to preferentially remove heat from the lower portion of the catalyst bed, thermal insulation means to preferentially obstruct heat flow from the sides and top of the catalyst bed, feed-through electrical wires to deliver operator controlled electrical power to a resistance heater that imposes a temperature gradient within the catalyst bed, and heat conduction means to deliver heat from the reactor to an application which the user desires to heat, with the heat delivery means being the interface between the reactor and room air, or being a heat exchanger system delivering heat to a more distant location.

2. The apparatus and process of claim 1 in which the spillover catalyst contains interfaces between nano-palladium and a non-metallic surface coating.

3. The apparatus and process of claim 2 in which the non-metallic surface coating is adsorbed water.

4. The apparatus and process of claim 1 in which the spillover catalyst bed contains multiple interfaces between nano-palladium and ionic crystals.

5. The apparatus and process of claim 4 in which the spillover catalyst is a ZrO₂+nano-palladium composite.

6. The apparatus and process of claim 4 in which the ionic crystals contain oxygen or fluorine or both.

7. The apparatus and process of claim 1 in which the spillover catalyst is a heterogeneous palladium catalyst consisting of nano-palladium in contact with ionic crystals, and in which the heterogeneous palladium catalyst contains adsorbed water.

8. The apparatus and process of claim 1 in which the spillover catalyst bed contains spillover catalyst which includes nano-metal crystallites supported on a porous substrate.

9. The apparatus and process of claim 8 in which the nano-metal crystallites are nano-palladium crystallites.

10. The apparatus and process of claim 1 in which the spillover catalyst bed contains spillover catalyst which includes nano-metal crystallites. supported on fibers, with the fibers assembled into a near-vertical bundle.

11. The apparatus and process of claim 10 in which the nano-metal crystallites are nano-palladium crystallites.

12. The apparatus and process of claim 1 in which the volumes containing catalyst, thermal insulation, and resistance heater are altered to create a desired temperature gradient in a direction other than upward.
